(19) United States
(12) Patent Application Publication
(10) Pub. No.: US 2003/0205864 A1
(43) Pub. Date: Nov. 6, 2003

(54) Rotary sealing device

(76) Inventors: Lannie L Dietle, Houston, TX (US); Manmohan S Kalsi, Houston, TX (US); Gunther Heidt, Calgary (CA); William T Conroy, Pearland, TX (US); Jeffrey D Gobeli, Houston, TX (US); John E Schroeder, Richmond, TX (US)

Correspondence Address: James L Jackson, Andrews & Kurth, 600 Travis, Suite 4200, Houston, TX, 77002, US

(21) Appl. No.: 10/296,327

(22) PCT Filed: Mar. 22, 2001
(86) PCT No.: PCT/US01/09048

(51) Int. Cl. F02F 5/00

(52) U.S. Cl. 277/434

(57) ABSTRACT

A contaminant pressure responsive, lubricant pressure amplified or modified rotary seal cartridge for rotary well pumps and other rotary mechanisms. A housing member having a passage subject to contaminant pressure, has a rotary wear sleeve which is supported by bearings and is sealed to the housing by a plurality of spaced seals which define at least one and preferably two or more lubricant chambers for bearing lubrication and for hydrodynamic sealing. Lubricant pressure amplification cylinders are in fluid communication with respective lubricant chambers. Pistons moveable within each of the cylinders define differential surface areas exposed to lubricant and to contaminant pressure. Contaminant pressure acts on the pistons and develops lubricant pressure which is different, preferably higher, but can be lower than contaminant pressure. When lubricant pressure is higher than contaminant pressure it acts directionally toward contaminant pressure or environment pressure to minimize the potential for contaminant intrusion into the lubricant chambers and also enhances the hydrodynamic wedging of the lubricant into the dynamic sealing interface between the seals and the rotary member for enhanced service life of the seals even under high pressure conditions.

### BACKGROUND OF THE INVENTION

1. Field of the Invention

The present invention relates generally to rotary sealing devices for hydrodynamically lubricated sealing between relatively rotating members. More specifically, the present invention concerns rotary cartridges for progressing cavity type artificial lift pumps, wherein such cartridges are provided with hydrodynamic sealing between relatively rotatable members, such as between a housing and a rotary sleeve or shaft and wherein the hydrodynamic seal or seals serve as one or more partitions between a contaminant environment and a lubricant. Even more specifically, the present invention concerns a contaminant pressure responsive, lubricant pressure amplified rotary rod seal cartridge for rotary shaft drive mechanisms, for establishing sealing at the shaft to reservoir interface and to prevent loss of process fluid from the oil and gas production reservoir. Also, the present invention concerns a rod seal cartridge for progressing cavity artificial lift pumps or injection pumps which contain a lubricant composition for lubrication of seals and wherein the supply of lubricant has a pressure being amplified above and responsive to the pressure of the contaminant environment region to provide a pressure differential across the seal which enhances resistance of the seals to contaminant intrusion.

2. Description of the Prior Art

Since progressing cavity pumps were introduced, they have steadily gained market share in artificial lift service because of significant and well-known economic and technical advantages over the beam pump. The progressing cavity artificial lift pump is relatively simple in principle concept, and consists of a compact surface mounted rotary drive head unit (sometimes called a “top drive”) and a submersed Moineau-type rotor-stator arrangement. The pump stator is attached to the lower end of the tubing, and the rotor is attached to the lower end of a rod string typically consisting of conventional lift pump sucker rods. The rod string and rotor are supported and rotationally driven by the surface mounted drive unit. Rotation of the rotor within the stator produces a pumping action to lift crude oil to the earth's surface. Progressing cavity pumps and top drives are also used as injection pumps for pumping high pressure fluids into wells.

The surface mounted drive unit is mounted to the well head, and provides a flow tee to direct the crude oil to a pipeline or suitable storage vessel. A conventional stuffing box is located above the flow tee to seal off the relatively rotating rod string drive shaft assembly which penetrates through the flow tee and stuffing box. The drive unit also incorporates a sealed and lubricated bearing housing assembly containing rotary bearings which axially and radially support a spindle/shaft which in turn supports the rod string. The spindle is rotationally driven by a prime mover such as an electric or hydraulic motor. The bearing housing and stuffing box are usually axially separated by a conventional yoke arrangement which provides the clearance needed to service the stuffing box, and which also provides the space needed to temporarily clamp-off the rod string to support the rod string weight in the event that the bearing housing assembly must be removed for service. The yoke is sometimes called a “booth” within the top drive industry. The surface mounted drive unit also incorporates coupling means to rotationally drive the rod string. In one popular embodiment, the bearing guided rotary spindle of the bearing housing is hollow and incorporates a hexagonal internal shape which engages and rotationally drives a hexagonal “slip shaft” which is in turn threadedly attached to the rod string.

One significant remaining weakness of present day progressing cavity artificial lift pumps has been the conventional stuffing box arrangement provided to seal-off the relatively rotating rod string as it enters the yoke area. The stuffing box is filled with conventional packing, which is a far from optimum solution for sealing liquids containing abrasive particulate matter, especially in conjunction with significant differential pressure, as is the case in the artificial lift pump application. Artificial lift pump stuffing boxes require frequent re-greasing and adjustment by means of a conventional packing gland follower to compensate for wear and minimize crude oil leakage. In many stuffing box applications such as low pressure pumps for non-abrasive liquids, lubrication provided by leakage contributes significantly to the life of the packing, but in the progressing cavity artificial lift pump, the leakage contains abrasives which accelerate packing wear, and cause corresponding wear of the mating rod surface. Adjusting the packing ring gland follower to control leakage is a matter of judgment, and over-tightening can cause high interfacial contact pressures which cause rapid packing failure, resulting in significant crude oil leakage. The packing of the present day progressing cavity artificial lift pump seals directly against the rod string, however a specially prepared rod called a “polished rod” or “polish rod” is provided. The polished rod is manufactured with better surface finish and dimensional tolerance than the remainder of the rod string, with a view towards providing a more suitable rotary sealing surface. Unfortunately, however, the surface of the polished rod quickly becomes damaged from handling and environmental exposure in ways that promote severe packing wear. For example, polished rod corrosion scale, pitting, and impact damage can be very detrimental to packing life. The drive heads of many progressing cavity artificial lift pumps permit significant dynamic run out of the polished rod, often in conjunction with severe rod string vibration. Such dynamic lateral shaft motion is difficult for any rotary sealing system to accommodate, and tends to wallow out the stuffing box packing and produce unacceptable crude oil leakage. Misalignment between the bearing housing and the stuffing box can also be a concern by creating uneven radial loading of the packing.

### SUMMARY OF THE INVENTION

It is a principal feature of the present invention to provide a hydrodynamically lubricated seal cartridge for the rotary drive heads of rotary artificial lift pumps for wells which utilizes well pressure for developing a lubricant pressure which is amplified to a pressure level above well pressure, thus providing pressure differential across the hydrodynamic seals to enhance resistance of the seals to contaminant intrusion into the lubricant chamber of the seal cartridge mechanism and to stimulate hydrodynamic wedging of lubricant into the dynamic sealing interface of the seals with the relatively rotatable surface of the rotary wear sleeve or other rotary element;

It is also a feature of the present invention to provide a hydrodynamically lubricated seal cartridge for the rotary drive heads of rotary artificial lift pumps having one or more pistons, which may be external of the seal cartridge or incorporated within the structure of the seal cartridge, which piston or pistons function as a pressure transferring wall of a lubricant chamber and are acted upon by contaminant pressure, also referred to as pump pressure;

An objective of the present invention is to provide a rotary seal cartridge for progressing cavity artificial lift pump drive heads which is readily adaptable to existing pumps and which provides longer maintenance intervals and service life, and accommodates higher pressure, compared to the conventional stuffing box sealing arrangements now used.

Another feature of the present invention is a bearing guided sleeve which rotates in unison with the polished rod, and provides a smooth, hardened, true running, abrasion resistant running surface for the rotary seals. By maintaining a constant, non-varying seal extrusion gap, this true-running sleeve preserves the life of the rotary seals by minimizing extrusion damage. This sleeve surrounds the polished rod, but runs true on it's own bearings and does not follow the dynamic run out and vibration induced lateral motion of the polished rod. The exceptionally true running characteristic of the sleeve is insured by (1) exploitation of the hydrostatic force of the pressure of the crude oil process fluid to preload one of the bearings in a way that eliminates internal bearing running clearance, (2) by spring loading of the opposite bearing in a way that eliminates internal bearing running clearance while accommodating differential thermal expansion, and in a way that simultaneously prevents slippage of the inner race and thereby eliminates wear and increased internal clearance that would otherwise result from said slippage, and (3) by axial clamping of the outer bearing races so that the necessary installation clearance between the outer race and the housing bore cannot contribute to dynamic run out. The clamping arrangement also makes the outer races immune from spinning within the housing bore in the event that bearing torque increases due to damage to the bearing running surfaces.

Briefly, the various objects and features of the present invention are realized through the provision of a contaminant pressure responsive, lubricant pressure amplified or modified rotary seal cartridge for rotary well pumps and other rotary mechanisms. The lubricant pressure amplified rotary seal cartridge has a housing member having a passage therethrough and having at least a portion of said passage being subject to contaminant pressure. A rotary member, such as a cartridge wear sleeve is disposed for rotation within said passage and is supported for rotation by a bearing assembly, such as one or more rotary cone bearings which accommodate both side loads and axial thrust loads to which the wear sleeve may be subjected. A plurality of spaced seals establish sealing between the housing member and the rotary member and define at least one and preferably two or more lubricant chambers between the housing and the rotary member. At least one and preferably two or more cylinders are provided, each having a lubricant supply chamber which is in fluid communication with a respective lubricant chamber. A piston is moveable within each of the cylinders and has a first surface area exposed to lubricant within the lubricant supply chamber and a second surface area being different from the first surface area and being exposed to contaminant pressure.

For purposes of the present invention, the term “contaminant pressure” is employed to define pressure from a well or other source which acts on the pistons in a direction toward the lubricant supply chambers of the cylinders. Contaminant pressure may be gas pressure from a well, the pressure of production fluid being pumped from a well or any pressurized liquid or gaseous medium being directed into the cylinders for the purpose of developing a lubricant pressure in response thereto. The term “ambient pressure” or “environment pressure” is defined as the pressure of the environment in which the seal cartridge mechanism is located.

The contaminant pressure acts on the second surface area and develops a lubricant pressure within the lubricant supply chamber which is different from contaminant pressure. Preferably the lubricant pressure is amplified above contaminant pressure so that the lubricant pressure within each of the lubricant chambers between the housing and rotary element establishes a pressure differential acting toward the lower pressure contaminant or environment. The higher lubricant pressure serves to hold the rotary seals straight, preventing skew-induced wear of the seals. Moreover, since the seals are preferably hydrodynamic seals, the higher lubricant pressure acts to enhance the wedging effect of the lubricant into the dynamic sealing interface between the seals and the rotary member by preventing process fluid pressure induced distortion of the hydrodynamic geometry of the seal.

If desired, the cylinder and piston assemblies may be arranged to develop pressure staging between the respective lubricant chambers to provided for effective hydrodynamic lubrication of each of the seals and to accommodate high pressure conditions that would otherwise cause failure of many types of seals. As a further alternative the cylinder and their respective chamber communication with the lubricant chamber or chambers between the rotary member and the housing and their respective communication with contaminant pressure may be arranged to develop lubricant pressure which is lower than contaminant pressure responsive to contaminant pressure acting on the pistons of the cylinders. Lubricant pressure may be staged by appropriate arrangement of the contaminant pressure responsive cylinder and piston assemblies to achieve lubricant pressure in one or more lubricant chamber which is higher than contaminant pressure and by achieving lubricant pressure in one or more lubricant chambers which is lower than contaminant pressure.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the preferred embodiment thereof which is illustrated in the appended drawings, which drawings are incorporated as a part hereof.

It is to be noted however, that the appended drawings illustrate only a typical embodiment of this invention and are therefore not to be considered limiting of its scope, for the invention may admit to other equally effective embodiments.

In the Drawings:

FIG. 1 is a sectional view of a contaminant pressure responsive, lubricant pressure amplified rotary rod seal cartridge constructed in accordance with the principles of the present invention and showing use of the housing member of the rod seal cartridge as a structural element of the top drive assembly that supports the yoke and the bearing housing assembly;

FIG. 2 is a partial sectional view of an alternative embodiment of the present invention employing a mounting flange that is integral with the housing member and adapted for bolted connection to pumped fluid flow control equipment;

FIG. 3 is a partial sectional view of another of another alternative embodiment of the present invention, showing a contaminant pressure responsive, lubricant pressure amplified rotary rod seal cartridge employing a threaded pin connection for mounting of the housing member to a flow tee or other pumped fluid flow control equipment;

FIG. 4 is a sectional view of a contaminant pressure responsive, lubricant pressure amplified rotary rod seal cartridge representing a further alternative embodiment of the present invention where the cartridge can be retrofit to existing top drive units by the use of adapters;

FIG. 5 is a sectional view of a contaminant pressure responsive, lubricant pressure amplified rotary rod seal cartridge representing a further alternative embodiment of the present invention and showing lubricant pressure amplifying cylinders being separate from the cartridge housing and supported by a common support base;

FIG. 6 is a sectional view of a contaminant pressure responsive, lubricant pressure amplified rotary rod seal cartridge representing another alternative embodiment of the present invention and showing pressure staging of the lubricant being supplied under pressure to the bearing chamber and the lubricant chamber between the hydrodynamic seals;

FIG. 7 is a sectional view of a contaminant pressure responsive, lubricant pressure amplified rotary rod seal cartridge representing a further alternative embodiment of the present invention and showing a rotary wear sleeve being secured in non-rotational relation with a rotary driven polished rod by means of a collet type seal retainer and clamp;

FIG. 7A is a partial sectional view of a rod seal cartridge representing a further alternative embodiment of the present invention and showing a rotary wear sleeve being secured in non-rotational relation with a rotary driven polished rod by means of a collet type seal retainer and clamp;

FIG. 8 is a sectional view of a contaminant pressure responsive, lubricant pressure amplified rotary rod seal cartridge representing another alternative embodiment of the present invention and showing hydrodynamic seals having direct sealing engagement with a rotary driven polished rod and with rotary stabilization of the polished rod by internal bearing surfaces of the cartridge housing and by one or more bushings seated within the housing;

FIG. 9 is a sectional view of a contaminant pressure responsive, lubricant pressure amplified rotary rod seal cartridge representing another alternative embodiment of the present invention and showing a housing structure having integral cylinders each having pistons being responsive to contaminant or pumped pressure and pressurizing lubricant with the cylinders at the same or different pressures;

FIG. 10 is a sectional view of an alternative embodiment of the present invention showing a seal cartridge housing having seals for sealing between the housing and a polished rod and illustrating communication of lubricant to the seals at an amplified lubricant pressure determined by contaminant pressure;

FIG. 11 is a sectional view similar to that of FIG. 10 and showing separation of the lubricant pressure amplification cylinder from a housing having the seals therein;

FIG. 12 is a fragmentary sectional illustration showing a housing having seals for sealing between the housing and a polished rod similar to that of FIGS. 10 and 11 a showing the seals as being a stack of O-ring energized lip seals; and

FIG. 13 is a sectional view of a contaminant pressure responsive, lubricant pressure amplified rotary rod seal cartridge representing another further embodiment of the present invention and showing a cartridge housing having integrated annular pistons therein each pressurizing lubricant at the same or different lubricant pressures responsive to contaminant pressure.

### DETAILED DESCRIPTION OF PREFERRED EMBODIMENT

Though the present invention is discussed herein particularly as it relates to rotary drive mechanisms for progressing cavity pumps, such discussion is not intended to limit the spirit and scope of the invention. The invention will also be found to have merit in any apparatus where a driven rotary shaft penetrates a vessel, reservoir, or other structure and is in contact with or contains a liquid so that a seal mechanism is required to contain the liquid and to protect portions of support means which may be in the form of a apparatus from contamination.

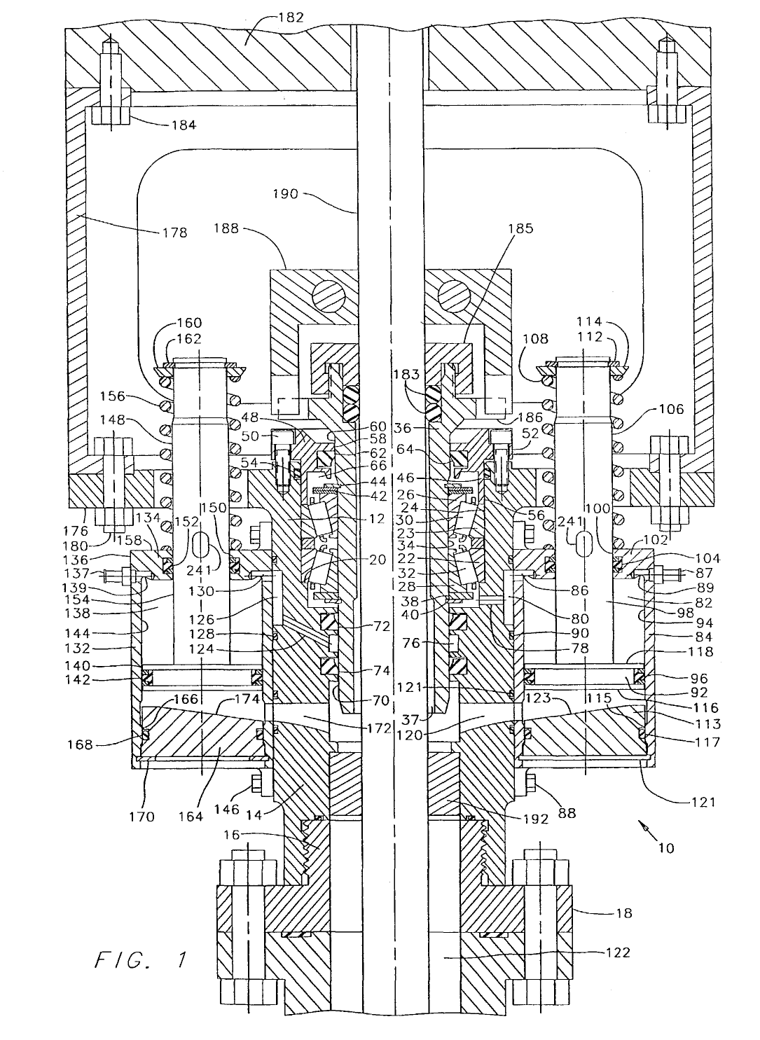

Referring now to the drawings and first to FIG. 1, a contaminant pressure responsive, lubricant pressure amplified rotary rod seal cartridge, such as is employed for rotary well pumps, such as rotary progressing cavity pumps, is shown generally at 10. The rotary rod seal cartridge 10 has a bearing and seal carrying housing 12 which is adapted at its lower end 14 for threaded assembly with a cartridge mounting base 16 which may be provided with a mounting flange 18 for bolted assembly of the cartridge 10 to a flow tee or to other wellhead structure as desired. It is understood that the cartridge mounting base 16 and the mounting flange 18 may vary widely in design and construction, since the wellhead and fluid flow components may vary widely from well to well.

The bearing and seal housing 12 defines an internal bearing locator shoulder 20 which provides for location of roller bearing races 22 and 23 which are received within an internal cylindrical bearing receptacle 24 of the housing 12. Roller bearing cones 26 and 28 of a wear sleeve bearing assembly have respective rolling bearing engagement with tapered roller bearing elements 30 and 32 and are disposed in bearing supporting engagement with the outer cylindrical surface 34 of a wear sleeve 36. The wear sleeve is supported for rotation and guided during rotation by the wear sleeve bearing assembly and defines a central passage 37 within which is received a polished rod 190 which is rotatably driven by a rotary pump rod drive mechanism 182. The term “polished rod” is conventionally used to describe a rod which is engaged by seals for the purpose of sealing the rod with respect to another structure. The rod is “polished” because it is prepared by finishing or plating and finishing to define an extremely smooth wear resistant surface for dynamic engagement by one or more seals. With respect to the wear sleeve 36 the lower portion of the roller bearing cone 28 is supported and located by a support ring 38 which is in turn supported by a retainer element 40, such as a snap ring or split ring which is retained within an annular externally opening groove of the wear sleeve. The upper portion of the roller bearing assembly is retained by a retainer assembly 42 which is in turn supported by a retainer ring 44 which is also received by an externally opening groove of the wear sleeve.

One of the tapered roller bearing cups 22 is retained seated against the internal bearing locator shoulder 20 by a depending generally cylindrical retainer extension of a bearing and seal retainer 48. The bearing and seal retainer 48 is retained in assembly with the housing 12 by retainer bolts 50 which extend through bolt openings of a retainer flange 52 of the bearing and seal retainer 48. An annular seal member 54 retained within an annular internal seal groove of the bearing and seal carrier housing 12 is disposed in sealing engagement with an annular external cylindrical surface 56 of the retainer extension 46, thus sealing the retainer 48 with respect to the housing 12. The bearing and seal retainer 48 defines an internal bore 58 which forms a part of a centrally located passage through the bearing and seal carrying housing 12.

The wear sleeve 36 defines a smooth, wear resistant outer sealing surface 60 which is engaged by an annular hydrodynamic sealing element 62 carried within an internally facing annular seal groove of the bearing and seal retainer 48, with the annular dynamic sealing surface of the seal in sealing engagement with the cylindrical polished sealing surface 60. The annular seal 62 is arranged with a hydrodynamic geometry 64 thereof oriented for contact with lubricant material contained within an annular bearing lubricant chamber or reservoir 66 which is defined between the housing 12 and the cylindrical polished surface 60 of the wear sleeve 36.

At its lower end portion, the wear sleeve 36 defines an outer coating 68 also composed of an abrasive resistant material such as nickel based tungsten carbide or any one of a number of other suitable wear resistant materials which defines a cylindrical polished surface 70 which is engaged by a pair of spaced annular hydrodynamic sealing elements 72 and 74 which are carried within spaced internally facing annular seal grooves of the bearing and seal retainer housing 12, with the annular dynamic sealing surfaces of the seals in sealing engagement with the cylindrical polished surface 70. Preferably, the annular sealing elements 72 and 74 are hydrodynamic seals embodying the principles of the hydrodynamic seals of commonly assigned U.S. Pat. Nos. 5,230,520 and 5,738,358. The uppermost one of the spaced sealing elements 72 and 74 is oriented with its axially varying hydrodynamic geometry 64 in communication with the lubricant of the annular lubricant chamber 66. The lowermost one of the spaced sealing elements 72 and 74 is oriented with its axially varying hydrodynamic geometry in communication with the lubricant of an annular lubricant supply groove 76 which is an internal groove of the bearing and seal retainer housing 12 located between the spaced sealing elements 72 and 74.

To supply the annular bearing lubricant chamber or reservoir 66 with lubricant at a desired lubricant pressure to be discussed in greater detail below, the bearing and seal retainer housing 12 defines at least one and preferably a plurality of lubricant supply passages 78 which are disposed in communication with an externally facing elongate, essentially vertically oriented lubricant supply groove or slot 80. The lubricant supply groove 80 is in fluid communication with a lubricant supply chamber 82 of a cylinder 84 via one or more lubricant supply passages 86 of the cylinder structure. For filling of the lubricant supply chamber with lubricant a suitable lubricant fitting 87 is fixed to the cylinder 84 and is in fluid communication with the lubricant chamber 82 thereof via a lubricant fill passage 89. The cylinder 84 is fixed to the bearing and seal retainer housing 12 by retainer bolts shown at 88 and is sealed to the housing 12 by an obround seal 90 such as an O-ring which encompasses the lubricant supply groove 80 and thus confines the lubricant to the lubricant supply groove. A piston 92 is moveable within the cylinder 84 and is sealed with respect to an internal cylindrical surface 94 of the cylinder by an annular high pressure seal 96. A piston stem 98 extends upwardly from the piston 92 through an opening 100 in the top wall 102 of the cylinder and is sealed with respect to the cylindrical surface defining the piston opening 100 by another high pressure seal 104 which engages a cylindrical external surface 106 of the piston stem. In order to achieve mechanically induced hydraulically enhanced pressurization of the lubricant within the lubricant supply chamber 82 of the cylinder, in absence of any pump pressure acting on the piston, a compression spring 108 is positioned about the piston stem with its lower end located against the upper wall 102 of the cylinder. The upper end of the compression spring 108 bears against a spring retainer 112 which is secured to the piston stem by a retainer ring 114 that is received by an external retainer groove of the piston stem.

The piston 92 defines a contaminant pressure responsive area 116 which is of greater dimension than a lubricant pressure responsive area 118, and to which contaminant pressure, which may also be referred to as pump pressure or well pressure, is communicated by a contaminant passage 120 of the bearing and seal retainer housing 12 with the well bore or fluid flow passage 122 of the flow tee or other pumped fluid flow control assembly. The contaminant passage 120 is sealed with respect to the cylinder structure and the bearing and seal retainer housing 12 by an obround sealing element 125 which is oriented about the passage 120 and disposed in sealing engagement with the external surface of the cylinder. Thus the pressure of the pumped well fluid or the gas pressure of the well being pumped acts on the contaminant pressure responsive area 116 of the piston 92 thus imparting an upward force to the piston which is added to the upward force of the compression spring 108. This upwardly directed force on the piston acts on the lubricant within the lubricant supply chamber 82 through the lesser pressure responsive area 118 of the piston and results in elevation or amplification of lubricant pressure in excess of contaminant pressure, the elevation or amplification being determined by the pressure responsive area ratio of piston surfaces 116 and 118. With the lubricant pressure in the annular lubricant reservoir 66 being greater than contaminant pressure acting within the pumped fluid flow passage 122, any differential pressure existing across any of the hydrodynamic seals will be in a direction from a lubricant chamber toward the contaminant or environment. This feature enhances the capability of the hydrodynamic seals to prevent intrusion of contaminant material into the lubricant supply either from the pumped fluid or from the environment within which the seal cartridge is located. The lubricant pressure prevents the hydrodynamic geometry of the seals from being distorted by the contaminant pressure, and also keeps the seals straight in their grooves to prevent the skew-related abrasive wear that could otherwise occur if the seals were not held straight. Also, due to the lubricant pressure being higher than the contaminant pressure, any increasing leakage that occurs past the rotary seals as they degrade will be lubricant leakage rather than abrasive laden contaminant leakage.

Since it is possible that contaminant laden pumped fluid may enter the cylinder via the passage 120 the plug member 113 is provided with a tapered upper surface 123 which minimizes the volume of contaminant fluid which may enter the cylinder. The tapered upper surface 123 also provides for drainage of any such fluid from the cylinder after the piston has reached the limit of its downward travel as contaminant fluid pressure is relieved.

In order to provide a supply of lubricant under similarly amplified pressure to the annular lubricant supply groove 76 to provide the hydrodynamic seals 72 and 74 with lubrication, the bearing and seal retainer housing 12 defines at least one lubricant supply passage 124 which is in communication with the annular lubricant supply groove 76 and with an external elongate generally vertically oriented fluid supply slot or groove 126. Lubricant pressure is confined to the lubricant supply groove 126 by an obround sealing element 128 which is retained in an external seal groove of the bearing and seal retainer housing 12. A lubricant supply passage 130 defined generally at the intersection of the side wall 132 and top wall 134 of a second lubricant pressure amplification cylinder 136 chamber establishes lubricant supply communication with an internal lubricant supply chamber 138 of the cylinder 136. For filling the internal lubricant supply chamber 138 with lubricant, a lubricant fitting 137 is fixed to the cylinder 136 and is in communication with the internal lubricant supply chamber 138 via a lubricant fill passage 139. The second pressure amplification cylinder is also secured to the bearing and seal retainer housing 12 by retainer bolts 146 or by any other suitable means for retention. A piston member 140 is moveable within the cylinder 136 and incorporates a high pressure sealing element 142 for maintaining dynamic sealing of the moveable piston member with an internal cylindrical surface 144 of the cylinder. A piston stem 148, which may be integral with the piston 140, extends through an opening 150 in the top wall 134 of the cylinder and is sealed with respect to the top wall 134 by a high pressure seal 152 which is retained within an internal seal groove of the top wall and establishes sealing engagement with an outer cylindrical surface 154 of the piston stem.

In order to achieve mechanically actuated hydraulically enhanced pressurization of the lubricant within the lubricant supply chamber 138 of the cylinder 136, in absence of any pump pressure acting on the piston, a compression spring 156 is positioned about the piston stem 148 with its lower end in engagement with the upper wall 134 of the cylinder. The upper end of the compression spring 156 bears against a spring retainer 160 which is secured to the piston stem by a retainer ring 162 received by an external retainer groove of the piston stem.

It should be borne in mind that the ratio of pressure amplification of the lubricant within the respective lubricant supply chambers 82 and 138 of the cylinders 84 and 136 will be determined by the pressure responsive area ratio of the contaminant pressure responsive and lubricant exposed surface areas of the respective pistons. This ratio may be changed by changing the dimension of the piston stems of the pistons. Thus, if a change in the amplification of lubricant pressure is desired, this can be accomplished simply by replacing one or both of the pressure amplification cylinders with cylinders having larger or smaller dimensioned piston stems.

The lower end of the cylinder 136 is closed by a plug member 164 which is sealed to the internal wall surface 166 of the cylinder by an annular sealing member 168 which is retained within an external seal groove of the plug member. The plug member 164 is retained within the cylinder by an annular retainer ring 170 located within an internal retainer groove at the bottom of the cylinder. The piston 140 and the plug member, together with the wall structure of the cylinder, define a contaminant pressure chamber 171. Since, as discussed above, it is possible that contaminant laden pumped fluid may enter the cylinder via a contaminant pressure supply passage 172 the plug member 164 is provided with a tapered upper surface 174 which minimizes the volume of contaminant fluid which may enter the cylinder. The tapered upper surface 174 also provides for drainage of any such fluid from the cylinder after the piston has reached the limit of its downward travel as contaminant fluid pressure is relieved.

At its upper portion the bearing and seal retainer housing 12 defines a mounting flange 176 having openings through which the upper ends of the piston stems extend. A yoke or housing member 178, sometimes called a “booth”, is secured to the mounting flange 176 by bolts 180 or by any other suitable means for assembly. The yoke 178 provides support for a bearing housing assembly, gearbox or other rotary drive mechanism 182, which is secured to the yoke by retainer bolts 184. This arrangement provides an important safety benefit, in that the lubricant fittings 87 and 137 are remote from the rotatable polished rod 190, which means that the pump doesn't have to be shut down to refill the lubricant cylinders 84 and 132. This allows the unit to be safely serviced in field conditions. This arrangement also provides an important cost reduction benefit, in that the housing 12 is integrated into the top drive assembly and serves as a necessary structural element to support the yoke 178 and bearing housing 182, thereby eliminating the cost that would otherwise be incurred by providing a separate structural member to support the yoke 178 and bearing housing 182.

At its upper end the wear sleeve 46 defines a drive flange 186 having drive receptacles that receive corresponding drive elements of a drive clamp 188 that is clamped to a polished rod 190 being driven by the bearing housing assembly, gearbox or other rotary drive mechanism 182. Thus, the drive clamp being driven by the rotating polished rod imparts rotation to the wear sleeve 36. The upper end of the wear sleeve defines a stuffing box having seals such as O-ring seals 183 therein for sealing between the polished rod 190 and the wear sleeve. A seal retainer 185 retains the seals 183 within the stuffing box, and is used to install the seals 183 into the stuffing box. The seal retainer is threaded to the upper portion of the wear sleeve and may be rotated as desired to establish proper mechanical compression of the seals 183 for proper sealing thereof with respect to the polished rod. During rotation of the wear sleeve, the wear sleeve is supported and stabilized with respect to the stationary housing 12 by the roller bearing assembly. A bushing 192, which may be composed of bronze or any other suitable bushing material, serves to stabilize the polished rod 190 with respect to the lower portion of the housing. The bushing 192 provides the additional function of providing a close clearance with the cylindrical surface of the polished rod 190 and minimizes entry of particulate into the pressure amplification cylinders. The minimal clearance of the bushing with the polished rod serves to exclude entry of large dimensioned particulate and minimizes entry of particulate of minimal dimension.

The piston stems 98 and 148 each define lubricant pressure relief recesses 241 and 242 respectively which are normally located above the respective circular stem seals 104 and 152. When the lubricant supply chambers of the respective cylinders 84 and 136 are filled via lubricant fittings 87 and 137, the respective piston is moved downwardly against the force of its compression spring. When the selected lubricant supply chamber has been filled to its maximum extent, the pressure relief recess of the filled cylinder will interrupt the stem seal of the cylinder and thus will vent a small quantity of lubricant past the seal under spring force, until the spring causes the pressure relief recess to disengage from the stem seal of the cylinder, thus permitting the stem seal to reestablish sealing with the piston stem. This feature provides the person filing the lubricant supply chamber with lubricant with a visual indication that the lubricant supply chamber is full, and prevents overfilling. If over-filling were permitted to occur, the thermal expansion of the lubricant could create very high lubricant pressure, resulting in damage to the rotary seals 62, 72 and 74, and also potentially yielding the various pressure-retaining structures, such as the pistons, the cylinders, etc. One advantage of the cylinder arrangement of the present invention is that the piston position provides a clear visual signal of seal performance; i.e. if a seal chamber has failed, the piston moves to the empty position. This means that one can merely drive by the well, without even getting out of one's vehicle, to ascertain seal chamber integrity. Piston position, and cylinder pressure, can also be monitored remotely by the use of appropriate position and/or pressure sensors in order to remotely monitor sealed chamber integrity. The dual-sealed chamber arrangement of FIG. 1, and of other FIGs. Herein, provides for redundancy. In the event that any one seal fails, the unit can continue to run without leakage of the pumped fluid to the environment.

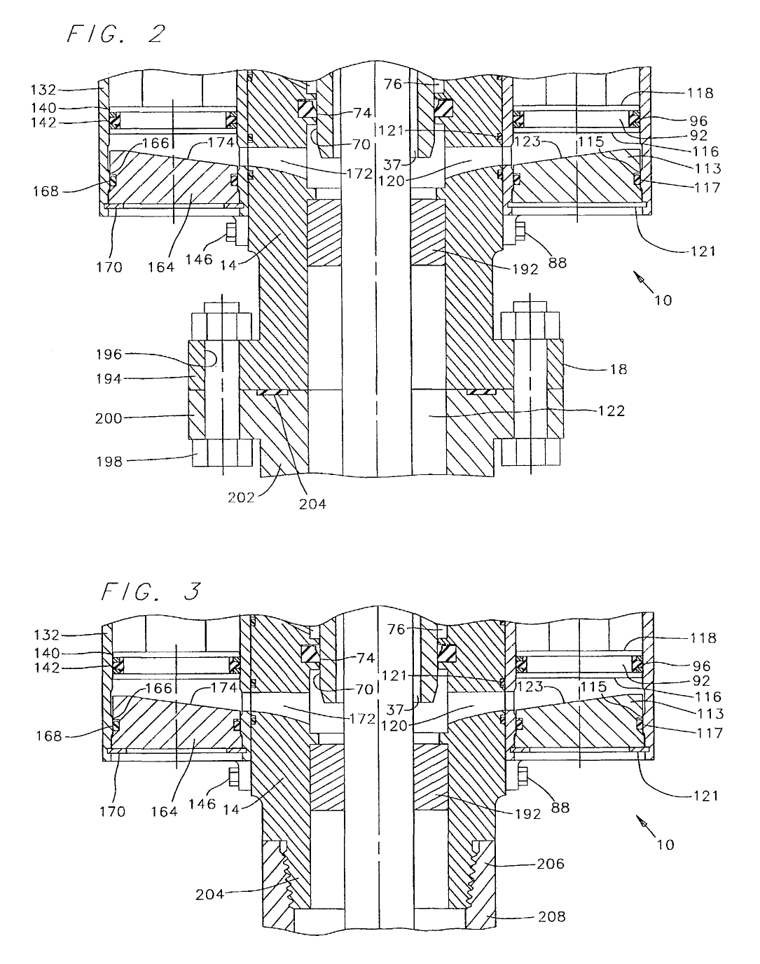

Referring now to FIG. 2, the partial sectional view illustrates a simplified alternative embodiment of the present invention, having like components which are referred to by like reference numerals as compared with the embodiment of FIG. 1. The housing structure 12 of the seal cartridge of FIG. 2 defines a lower housing end 14 having an integral mounting flange 194 having a circle of bolt openings 196 receiving mounting bolts 198 for securing the mounting flange to the support flange 200 of a flanged flow tee or other flow control structure 202 from which fluid is pumped by the rotary pump mechanism. A seal member 204 is employed for sealing between the mounting flange 194 and the support flange 200. Though not shown for purposes of simplicity, the flanges 194 and 200 may also be provided with sealing surfaces for metal to metal sealing as well as or in lieu of various joint seals.

In the alternative embodiment of FIG. 3 the housing structure 12 is shown at its lower end 14 to be provided with a standard externally threaded pin connection 204 which is received within a conventional internally threaded box connection 206 of a tubular flow control member 208 such as a flow tee or flow conduit.

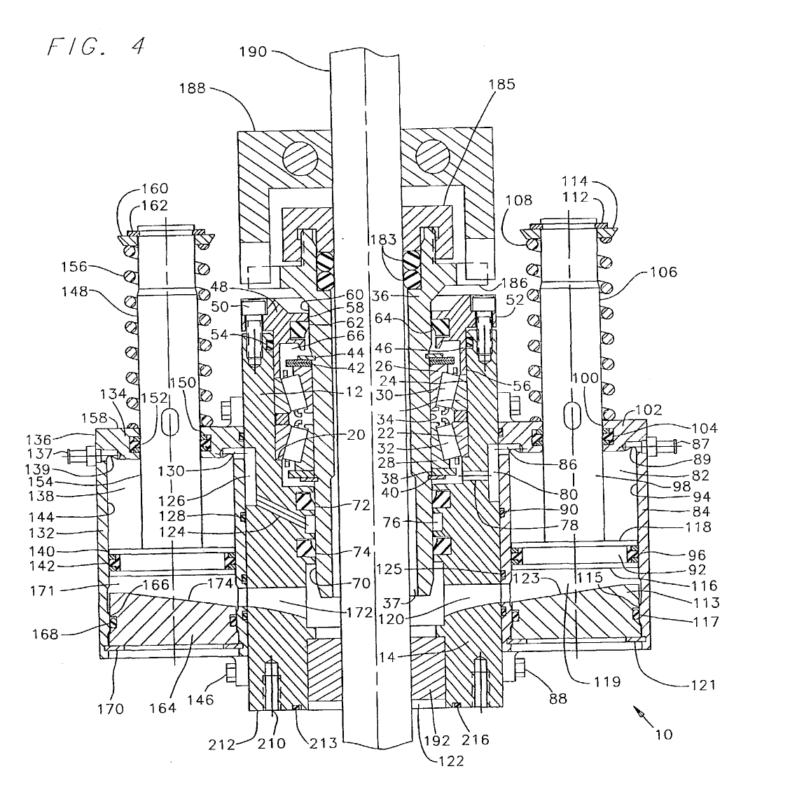

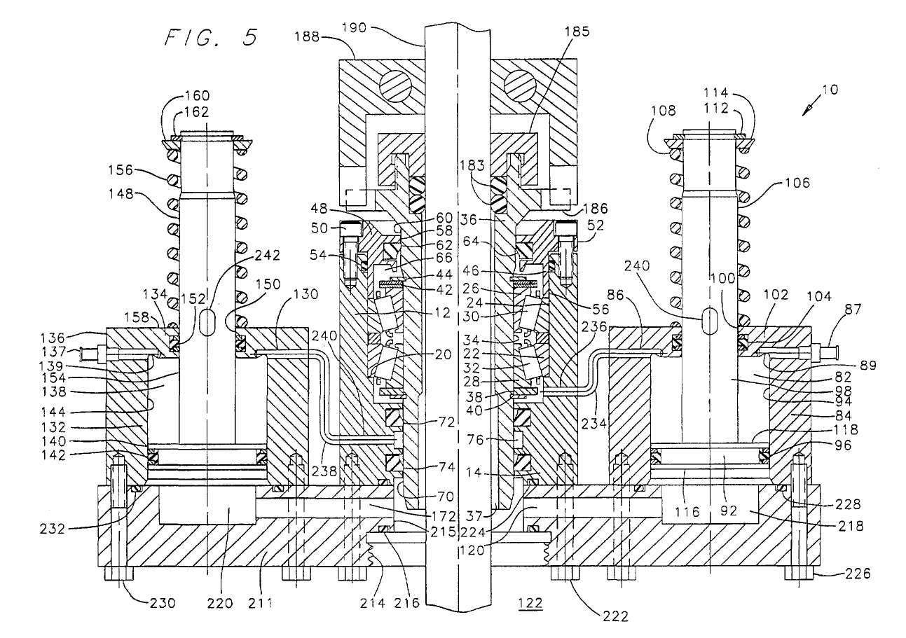

Referring to FIG. 4, the alternative embodiment shown varies from that shown in FIG. 1 only in that the housing element 12 defines a lower end 14 having a circle of internally threaded bolt openings 210 at the lower mounting end 212 for mounting of the housing to a suitable support flange, adapter or other supporting structure, not shown. Thus, like components are referred to by like reference numerals. A sealing element 213 is employed to establish sealing of the lower end 14 of the housing 12 to the support to which the housing is mounted. In this embodiment, the housing structure is not required to function additionally as a structural member for support of a drive head support yoke as in FIG. 1. The support flange or other support structure in this case would also provide structural support for a drive head support yoke, thus permitting the housing to be structurally designed only for support of the external cylinders 84 and 136. This feature will permit the housing to be manufactured at significantly less cost as compared to the embodiment of FIG. 1, and allow it to be retrofit to many different types of top drives by the use of various adapters.

Referring now to FIG. 5, in comparison with FIG. 1 and other FIGS., like components are referred to by like reference numerals for purposes of simplicity and to facilitate ready understanding to the invention. A common mounting base 211 is provided to provide support for the cartridge housing 12 and to support the cylinders when the cylinders are not connected in supported relation with the housing. The mounting base 211 has a central opening 215 through which the polished rod 190 extends and defines an internally threaded mounting receptacle 214 having a circular sealing element 216 located within a circular seal groove. When a mounting adapter, a threaded flow tee or other flow control conduit is threaded into the mounting receptacle 214 the circular sealing element 216 establishes sealing with the circular end surface thereof, thus sealing the threaded flow tee or other flow control conduit to the common mounting base 211. The common mounting base 210 also defines contaminant pressure communicating passages 120 and 172 which each communicate with the contaminant fluid pressure within the well bore or pumped fluid passage 122. The contaminant pressure communicating passages 120 and 172 also communicate with cylinder receptacles 218 and 220 which form portions of the contaminant fluid pressure receiving cylinder chambers of the cylinders 84 and 136, respectively. Mounting bolts 222 extend through openings in the mounting base 211 and are received by corresponding internally threaded bolt openings of the lower end 14 of the housing member 12 and function to secure the housing member firmly to the mounting base. An annular seal element 224 establishes sealing at the interface of the lower end of the housing member with the mounting base 211 and prevents leakage of contaminant pressure from contaminant or pumped fluid flow passage 122. Likewise, the cylinder 84 is mounted to the common support base 211 by mounting bolts 226 and is sealed with respect to the support base by an annular sealing element 228. Similarly, cylinder 136 is mounted to the base 211 by mounting bolts 230 and is sealed to the mounting base by an annular sealing element 232.

To establish lubricant communication from the lubricant supply chamber 82 with the lubricant chamber 66 to provide for lubrication of the bearing assemblies and to provide lubricant to the annular hydrodynamic sealing elements 62 and 72, a lubricant supply conduit 234 is connected in communication with the lubricant supply passage 86 of the cylinder 84 and is also connected in communication with a lubricant supply passage 236 of the housing, which generally corresponds in construction and function to the lubricant supply passage 78 of FIG. 1. Thus, as the piston 92 is urged upwardly by the compression spring 108 or is forced upwardly by contaminant pressure acting on the pressure exposed surface area 116 of the piston, the lubricant within the lubricant supply chamber 82 of the cylinder 84 is pressurized and is conducted via the lubricant supply conduit to the lubricant chamber 66 between the housing 12 and the rotary wear sleeve 36. The pressure of the lubricant being communicated to the lubricant chamber 66 will be determined by the spring force of the compression spring and by the area differential defined by the contaminant pressure and lubricant exposed areas of the piston 92. In the same manner, the lubricant supply chamber 138 of the cylinder 136 is communicated with the lubricant chamber 76 between the hydrodynamic seals 72 and 74 by a lubricant supply conduit 238 which has one end thereof in communication with the lubricant supply passage 130 of the cylinder 136 and its opposite end in communication with a lubricant supply passage 240 essentially corresponding to the lubricant supply passage 124 of FIGS. 1 and 4. Thus, as the piston 140 is moved upwardly by the force of its compression spring 156 or the combined force of the compression spring and the force developed by contaminant pressure acting on the piston, the lubricant present within the lubricant supply chamber 138 is subjected to pressure by the piston force, thus supplying pressurized lubricant to the annular lubricant supply groove between the hydrodynamic seals 72 and 74.

The piston stems 98 and 148 each define lubricant pressure relief recesses 241 and 242 respectively which are normally located above the respective circular stem seals 104 and 152. When lubricant is injected into the lubricant supply chambers of the respective cylinders 84 and 136 via lubricant fitting s 87 and 137, the respective piston is moved downwardly against the force of its compression spring. When the selected lubricant supply chamber has been filled to its maximum extent, the pressure relief recess of the filled cylinder will interrupt the stem seal of the cylinder and thus will vent a small quantity of lubricant past the seal under spring force, until the spring causes the pressure relief recess to disengage from the stem seal of the cylinder, thus permitting the stem seal to reestablish sealing with the piston stem. This feature provides the person filing the lubricant supply chamber with lubricant with a visual indication that the lubricant supply chamber is fall, and prevents over-filling. If over-filling were permitted to occur, the thermal expansion of the lubricant could create very high lubricant pressure, resulting in damage to the rotary seals 62, 72 and 74, and also potentially yielding the various elements of the device, such as the cylinders 84 and 36, the bolts 50, 222 226 and 230, the housing 12, the pistons 92 and 140, and the bearing and seal retainer 48.

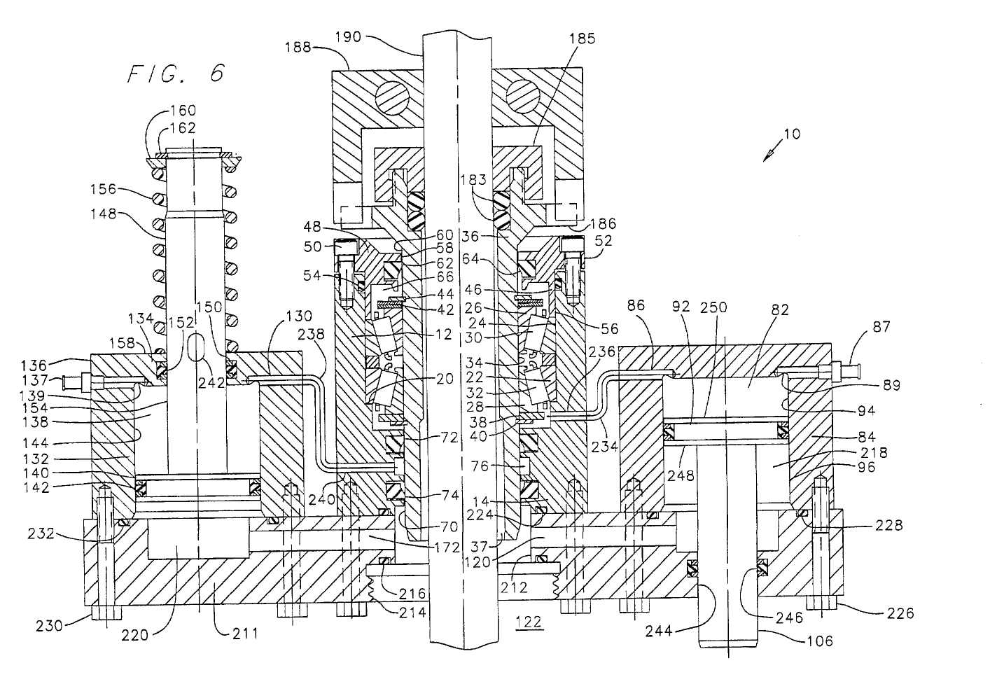

Referring now to FIG. 6, an alternative embodiment of the present invention is shown which is responsive to contaminant pressure and spring force and which accomplishes pressure staging of lubricant pressure to the isolated lubricant chambers of the rod seal cartridge mechanism. Since the seal cartridge mechanism is mounted to a common base structure 211 in similar manner as discussed above in connection with FIG. 5, like parts are referred to by like reference numerals. The cylinder 136 is mounted to the common base 211 in the manner discussed above in connection with FIG. 5 and the pressurized lubricant of the lubricant supply chamber 138 is communicated to the annular lubricant chamber defined partially by the annular groove 76 between the hydrodynamic seals 72 and 74. Thus, the lubricant pressure being supplied to the lubricant chamber from the lubricant supply chamber of the cylinder has a ratio of lubricant pressure with respect to contaminant pressure similar to that discussed above.

As shown at the right hand portion of FIG. 6, the lubricant supply chamber 82 of the cylinder 84 is in communication with the lubricant chamber 66 via passage 86, supply conduit 234 and supply passage 236. The piston 92 is inverted with respect to the embodiments of FIGS. 1 and 5, thus the piston stem 106 projects downwardly from the piston and through a piston opening of the common base structure 211 and is sealed with respect to the common base structure by an annular high pressure sealing assembly 246. Thus, the piston 92 defines a smaller contaminant pressure exposed area 248 of the piston as compared to the piston area 250 with which the lubricant of the lubricant supply chamber is in contact. This phenomenon causes the lubricant pressure of the lubricant chamber 66 to be less than the contaminant pressure to which the piston is exposed and causes the lubricant pressure within the lubricant chamber 76 to be greater than the lubricant pressure of the lubricant chamber 66 and greater than the contaminant pressure acting on both of the pistons 92 and 140. This pressure staging arrangement is particularly useful in injection pumps, where the pressure of the fluid being pumped is relatively high, because the pressure is divided among several seals.

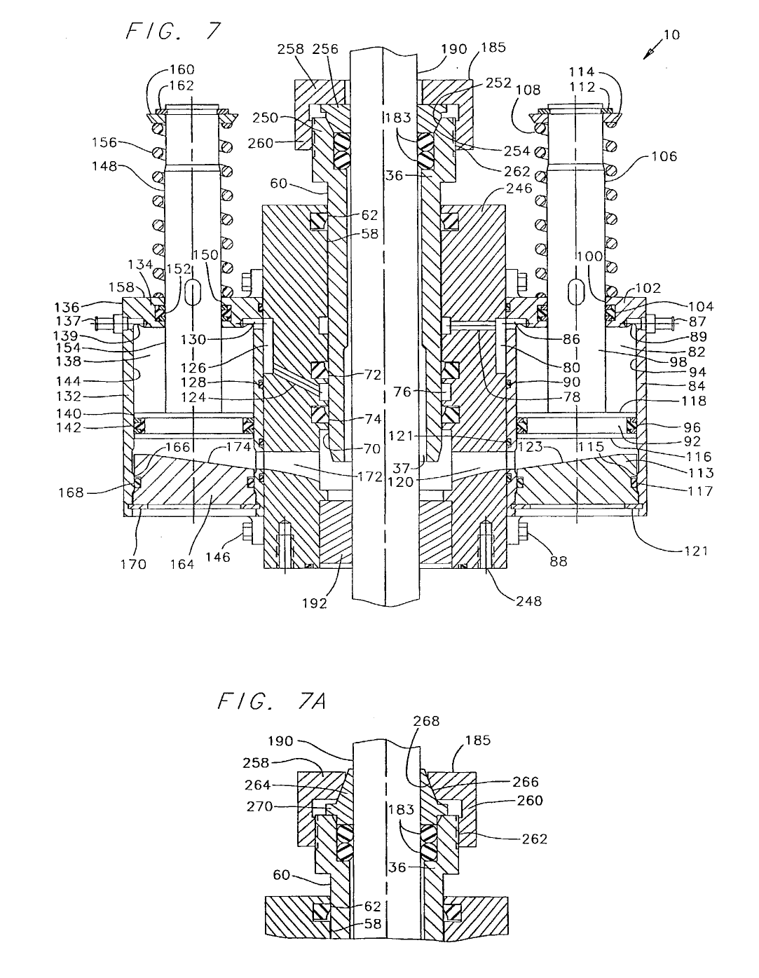

FIG. 7 of the drawings is a sectional view similar to that of FIG. 1, but showing the rotatable wear sleeve being supported in non-rotational relation with the polished rod by a collet type clamp and seal retainer which achieves radial and axial positioning of the rotary wear sleeve with respect to the polished rod, thus causing the wear sleeve to rotate with precision concentricity with respect to the polished rod, and causing the wear sleeve to be positioned axially by the polished rod, the polished rod in turn being supported by the bearings of the bearing housing assembly (not shown) as discussed previously. Like parts, in comparison with FIG. 1 are referred to by like reference numerals. The contaminant pressure responsive, lubricant pressure amplified rotary rod seal cartridge 10 includes a seal carrier housing 246 which is adapted at its lower end with threaded bolt openings 248 for receiving mounting bolts for securing the housing to a support structure such as an adapter or mounting flange. The housing 246 defines a generally cylindrical internal bearing surface 58 which serves as a bearing or bushing for journaled engagement with a generally cylindrical outer surface 60 of a rotary wear sleeve 36. Thus, in essence, the generally cylindrical internal bearing surface 58 provides a simple, low cost bearing or bushing arrangement for the rotary rod seal cartridge mechanism. A bushing 192, which may be composed of bronze or any other suitable bushing material, serves to stabilize a polished rod 190 with respect to the lower portion of the housing. The bushing 192 provides the additional function of providing a close clearance with the cylindrical surface of the polished rod 190 and minimizes entry of particulate into the pressure amplification cylinders. The minimal clearance of the bushing with the polished rod serves to exclude entry of large dimensioned particulate and minimizes entry of particulate of minimal dimension. Annular seals 62, 72 and 74 are located within annular internal seal grooves of the housing 246 and establish sealing with the outer cylindrical surface 60 of the wear sleeve. Preferably, the annular seals 62, 72 and 74 are hydrodynamic seals for hydrodynamically enhanced lubrication of the sealing interface of the seals with the wear sleeve.

It is necessary that the wear sleeve be sealed to and rotate along with the polished rod during operation of the pump mechanism or other rotary actuated mechanism. The upper end of the wear sleeve defines a stuffing box having seals such as 0-ring seals 183 therein for sealing between the polished rod 190 and the wear sleeve. The upper end portion 250 of the wear sleeve defines an internal tapered cam surface 252 which is engaged by a correspondingly tapered external surface 254 of a seal retainer element 256 in the form of a collet. A seal retainer cap element 185 defines a top wall 258 defining an opening through which the polished rod 190 extends and defines an internally threaded side wall 260 which is received in threaded engagement by an externally threaded section 262 of the upper end portion 250 of the wear sleeve. As the seal retainer cap is threaded onto the externally threaded upper end of the wear sleeve the top wall of the seal retainer cap forces the seal retainer element 256 downwardly and causes the tapered surfaces 252 and 254 to interact in cam-like fashion to drive the seal retainer element radially inwardly into gripping relation with the outer surface of the polished rod 190 and thus frictionally securing the seal retainer element and thus the wear sleeve in non-rotatable, axially fixed relation with the polished rod. Simultaneously, downward movement of the seal retainer element may compresses the seal members 183 and to enhance the sealing capability thereof.

The partial sectional view of FIG. 7A discloses an alternative seal retainer and collet clamp mechanism as compared to that of FIG. 7. In this case, a collet type seal retainer and clamp element 264 defines a tapered outer surface 266 which is engaged by an internally tapered surface 268. As the retainer cap 185 is rotated for tightening on the threaded section 262 of the wear sleeve, the collet clamp element 264 is driven radially inwardly by the reaction of tapered surfaces 266 and 268 for clamping engagement with the outer surface of the polished rod and thus frictionally securing the seal retainer element and thus the wear sleeve in non-rotatable, axially fixed relation with the polished rod. An annular stop flange 270 engages the upper end of the wear sleeve and prevents over-compression of the annular sealing elements 183 as the retainer cap is further threaded to enhance the gripping effect of the collet type seal retainer and clamp 268.

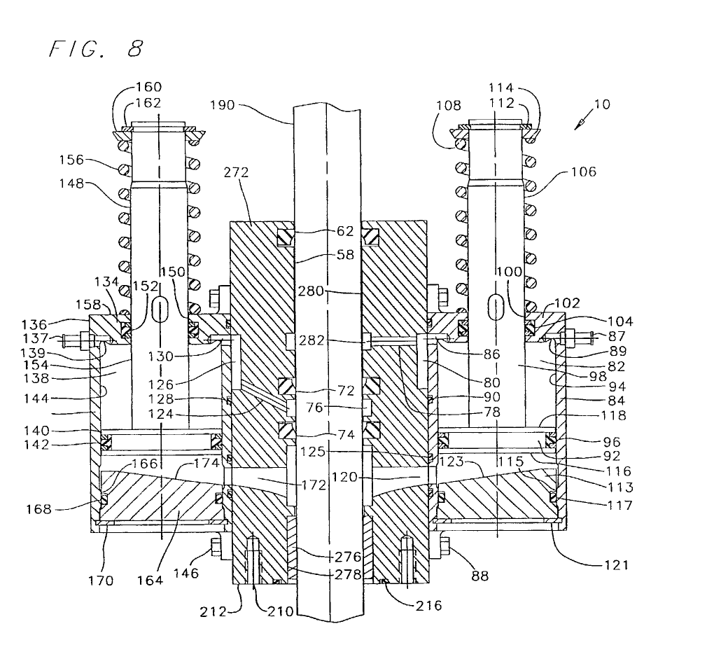

The present invention is also applicable to situations where the use of a rotary sleeve is not desired or deemed appropriate. As shown in the sectional view of FIG. 8, an alternative embodiment is shown which incorporates many of the features shown and described above in connection with FIG. 4. Thus like components of these Figures are referred to by like reference numerals. The contaminant pressure responsive, lubricant pressure amplified rotary rod seal cartridge 10 of FIG. 8 incorporates a bearing and seal carrier housing 272 having a circle of bolt openings 210 at its lower end 212 for mounting of the housing to a base or other support structure. A circular sealing element 216 provides for sealing of the housing with respect to the base, adapter or other support structure. The housing defines an internal bore 58 which is dimensioned for bearing or journaled engagement by the external cylindrical surface of the polished rod 190. A bushing 276, typically composed of bronze or other suitable journal material, is retained within a bushing receptacle 278, and has journaled engagement with the outer cylindrical surface of the polished rod and functions to provide for additional stabilization of the polished rod as it is rotated within the seal cartridge.

A plurality of annular seals 62, 72 and 74 are retained within internal seal grooves of the housing 272 with sealing surfaces thereof disposed in dynamic sealing engagement with the outer cylindrical surface of the polished rod 190. Preferably the seals 62, 72 and 74 are hydrodynamic seals of the nature described above. To provide for lubrication of the bearing interface between the housing and the polished rod and between the seals 62 and 72, the lubricant supply chamber 82 of the lubricant pressure amplification or modification cylinder 84 is in communication with the housing/polished rod interface 280 via passages 86, 80 and 78 and by annular lubricant supply groove 282. Thus, the lubricant being conducted to the housing/polished rod interface 280 will be at a lubricant pressure determined by the force of the compression spring 108 and the pressure of any contaminant medium acting on the contaminant pressure responsive area 116 of the piston 92.

The annular region between the seals 72 and 74 is supplied with pressurized lubricant from the lubricant supply chamber 138 of the cylinder 136 via passages 130, 126, 124 and 76 such as is discussed in detail hereinabove. Thus, all of the seals 62, 72 and 74 are efficiently supplied with lubricant, with the pressure of the lubricant being determined by contaminant pressure acting on the respective pistons of the cylinders and being combined by the force of the compression springs 108 and 156.

FIG. 9 is a sectional view of a further alternative embodiment of the present invention, shown generally at 10, having an integral housing and lubricant pressure amplification system for the rotary rod seal cartridge, thus simplifying manufacturing costs and resulting in a rotary seal cartridge mechanism that can be efficiently manufactured. The contaminant pressure responsive, lubricant pressure amplified rotary rod seal cartridge 10 is provided with a body structure 12 having an upper portion thereof constructed essentially as shown in FIGS. 4, 5 and 6. From the lower portion of the body structure 12 projects a pair of cylinders 84 and 136 which are preferably integral with the body structure as shown, but which may be assembled in any suitable fashion to the body structure. Preferably, the cylinders 84 and 136 are arranged in diametrically opposed relation, but such orientation is not required within the sprit and scope of the present invention. Within the cylinder 84 a piston member 92 is moveable and is sealed with respect to an internal cylindrical surface 94 of the cylinder by an annular sealing element 96. A piston stem 98 projecting from one side of the piston 92 extends through a seal 104 which is carried by a removable cylinder wall 284 which is secured within the cylinder 84 by a retainer ring 286 received within an internal retainer groove defined within the end of the cylinder. The end wall 284 is sealed with respect to the cylinder by an annular sealing element 288.

The piston, cylinder and end wall collectively define a lubricant supply chamber 82 which is supplied with lubricant via a lubricant supply fitting 87 and passage 89. The piston stem 98 defines an external tapered pressure relief recess shoulder 290 which normally is located outwardly of the annular seal 104 of the removable cylinder wall 284. In the event sufficient lubricant is injected into the lubricant supply chamber 82 to drive the piston 92 beyond its desired limit of travel, the tapered pressure relief recess shoulder 290 will move into the annular seal 104, thereby breaking its seal with the piston stem and permitting leakage of lubricant to occur. Additionally, the lubricant venting feature is important to prevent damage to the seal cartridge mechanism in the event a condition of thermal expansion of the lubricant should occur. As the lubricant is heated, either by changes in ambient temperature or by seal fiction induced heat build-up during rotary pump operation, the thermally expanding lubricant will drive the piston in a direction toward the contaminant. At the point of maximum allowable travel of the piston the tapered pressure relief shoulder with move to venting position with respect to the stem seal of the piston and cylinder assembly thus venting excessive lubricant pressure from the cylinder. Immediately upon venting, the piston stem will again be moved by the spring 108 to its sealed position with respect to the stem seal. This lubricant venting feature provides a visual indication that the cylinder is completely filled with lubricant and also minimizes the potential for damaging internal components of the cylinder or seal cartridge by over-filling and lubricant thermal expansion. For example, if seal 72 is a hydrodynamic seal, the hydrodynamic pumping action thereof could potentially over-fill lubricant supply chamber 138 in the absence of the lubricant venting pressure relief 297 of piston 140. The tapered or chamfered pressure relief shoulder also serves a guiding function to guide the piston stem through the cylinder top wall seals during assembly of the pistons with the cylinders. For supplying pressurized lubricant from the lubricant supply chamber 82 of the cylinder 84, a lubricant supply passage 86, extending through a structural member 292 is in communication with the lubricant chamber 66 within which the roller bearing assemblies are contained. Thus, the roller bearing assemblies are efficiently lubricated during rotation of the wear sleeve. The pressurized lubricant within the lubricant chamber 66 also furnishes the annular sealing elements 62 and 72 with lubricant. Preferably, seals 66, 72 and 74 are hydrodynamic seals so that movement of the lubricant during rotation of the wear sleeve 36 develops hydrodynamic wedging of lubricant into the dynamic sealing interface between the seals and the relatively rotatable surfaces of the rotary wear sleeve.

The opposite cylinder 136 is also provided with a removable cylinder wall 294 which is secured within the end of the cylinder by a retainer ring 296 or other suitable method, such as a circle of threaded fasteners, and is sealed with respect to the cylinder by a seal ring 298. A lubricant supply passage 130 extends through another structural element 300 and communicates the lubricant supply chamber 138 of the cylinder with the annular lubricant supply groove 76 which forms a part of a lubricant chamber between the housing and the rotary wear sleeve and between the sealing elements 72 and 74. The contaminant pressure present within the pumped fluid or contaminant passage 122 acts simultaneously on the pistons 92 and 140 and thus simultaneously develops pressures within the respective lubricant supply chambers which is dependent upon the differential area ratio of the surface areas of the pistons which are exposed to contaminant pressure and the surface areas of the pistons which are in contact with the lubricant. Thus, the lubricant pressures being communicated to the respective lubricant chambers may be different if desired. The integral housing and cylinder arrangement shown in FIG. 9 is easily manufactured by simple techniques, such as casting and lathe turning. Mill work is minimized by this construction, greatly reducing the cost of the assembly.

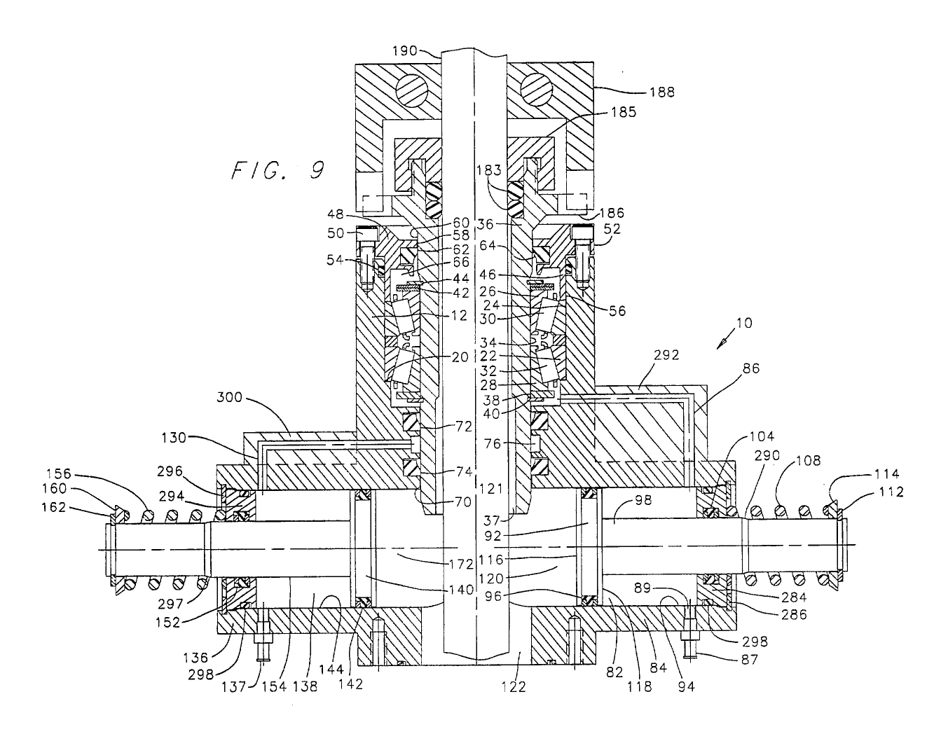

Within the spirit and scope of the present invention, lubricant at a pressure amplified by contaminant pressure may be communicated directly to seals that establish sealing between the housing 12 and polished rod 190. With regard to FIG. 10, the removable cylinder 132 is mounted to the seal cartridge housing 12 by mounting bolts 146. The region within the cylinder 132 below the piston member 140 is in communication with the annular contaminant or pumped pressure via the passage 172 of the cartridge housing 12. In this case the chamber or passage 172 is at pump or well pressure via housing clearance with the polished rod 190 and the clearance of the bushing 276 with the polished rod. Lubricant is communicated from the lubricant supply chamber 138 of the cylinder 132 by a lubricant supply passage 130 of the cylinder and by a lubricant supply passage 86 which is in communication with a lubricant chamber 66 within which seals 72 are also located. If desired, the seals 72 may be hydrodynamic seals such as indicated above, or the seals may have any other suitable geometry as desired. Centrally of the stack of seals 172 a lantern ring 285 is located to maintain the central seals of the seal stack in spaced relation so that the pressurized lubricant is conducted essentially centrally of the seal stack. The seals 72 are retained by a seal retainer 287 which is secured to the housing 12 by retainer bolts 289.

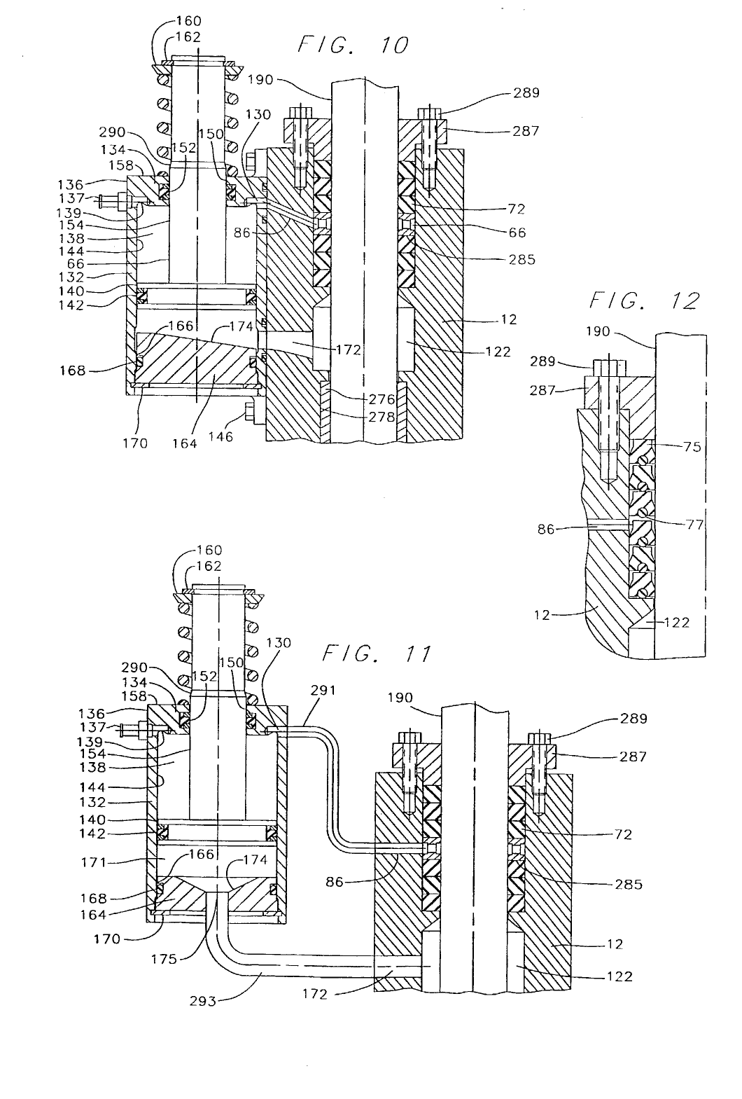

The embodiment of FIG. 11 differs from the embodiment of FIG. 10 in that the cylinder 136 is separated from the cartridge housing 12 and the lubricant and contaminant pressures are communicated from the cylinder to the housing by means of supply conduits. The lubricant supply passage 130 from the lubricant supply chamber 138 and the lubricant supply passage 86 of the housing 12 are in communication with a lubricant supply conduit 291 for conducting pressurized lubricant to the lubricant chamber in which the seals 72 and located. A contaminant or pumped fluid supply conduit 293 is connected to the cylinder closure plug member 164 and is in communication with the contaminant pressure supply passage 172 to the cartridge housing 12 for communicating contaminant or pumped fluid pressure from the well fluid or pumped fluid passage 122 into the contaminant pressure chamber 171 of the cylinder. The plug member 164 defines a tapered surface 174 which tapers to the central opening 175 of the plug member, thus draining contaminant fluid, which may contain some solid components from the contaminant pressure chamber 171, thus minimizing the contaminant material to which the seal 142 of the piston may be subjected.

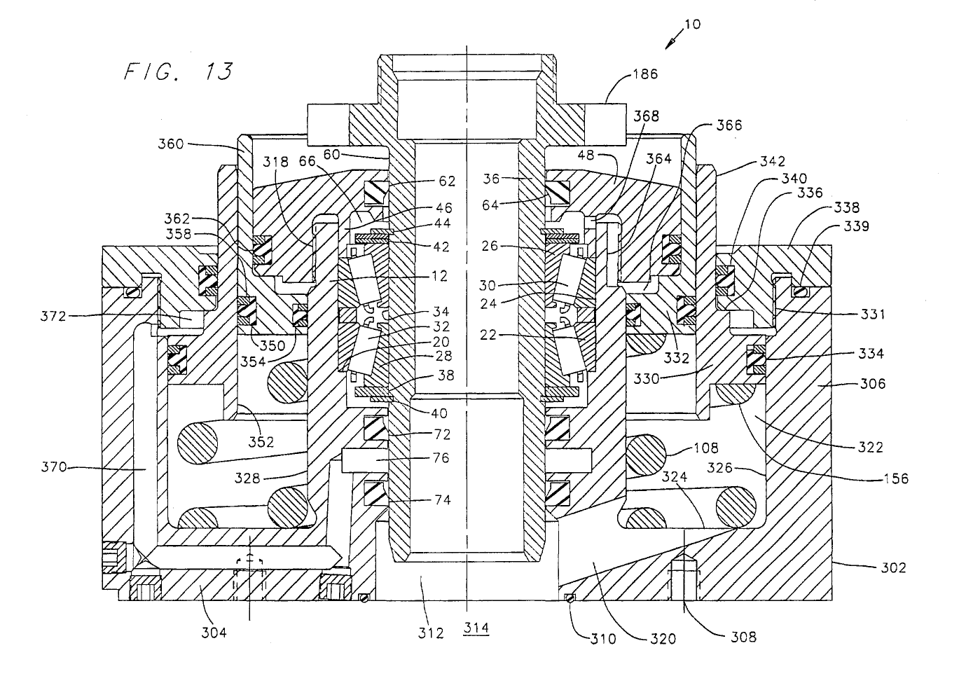

FIG. 12 basically discloses the housing 12, seal retainer 287 and polished rod 190 which corresponds to FIGS. 10 and 11. A plurality of seals 77, which may be of any suitable type such as the O-ring energized lip seals shown, are positioned in stacked relation and establish sealing between the housing 12 and the polished rod 190. Centrally of the seal gland, where the gland is intersected by the lubricant supply passage 86, the seals are spaced, with the upper seals being subjected to upwardly directed force responsive to lubricant pressure and with the lower group of seals of the seal stack being forced downwardly by lubricant pressure. As with the other arrangements, any leakage past the seals will be clean lubricant, rather than the potentially abrasive-laden fluid from fluid passage 122.

Referring now to FIG. 13 of the drawings is a sectional view showing a contaminant pressure responsive lubricated rotary rod seal cartridge generally at 10 having a housing 302 having a bottom wall 304 and a side wall 306. The bottom wall 304 is provided with threaded bolt holes 308 which receive mounting bolts for mounting the housing to a support base, adapter or any other suitable support structure. A seal 310 is received within an annular seal groove of the bottom wall 304 for sealing the bottom wall to the support base and preventing leakage of contaminant pressure. The bottom wall 304 also defines a centrally oriented recess 312 which is in communication with a pumped fluid supply passage 314. The centrally oriented recess 312 also defines a portion of a centrally located wear sleeve passage 316 extending through the housing 302.

The housing structure 302 also defines an interior bearing and seal support housing which corresponds in structure and function with the housing 12 and is thus referred to by the same reference numeral. Other like components are also referred to by like reference numerals. The interior bearing and seal support housing 12 is integral with and projects upwardly from the bottom wall 304 and defines an internal bearing locator and support shoulder 20 which provides for location and support of roller bearing cup 22 of one or more roller bearing assemblies located within an internal cylindrical bearing receptacle. The bearing assemblies have inner roller bearing cones 26 and a plurality of tapered roller members 30, but may take any other suitable form within the spirit and scope of the present invention. A rotary wear sleeve 36 is supported by the bearings within the centrally located passage 314 and is retained in relation to the bearing assemblies by support rings 38 and 42 and retainer rings 40 and 44. A retainer element 48 has threaded assembly with the upper externally threaded section 318 of the interior bearing and seal carrying housing 12. The bearings are retained seated against the internal bearing locator and support shoulder 20 by a depending annular retainer extension 46 which may be integrated with, or separable from retainer element 48.

An annular seal 62, which may be a hydrodynamically lubricated sealing element is carried with an annular seal groove of the retainer element 48 and is disposed in sealing engagement with the outer cylindrical polished surface 60 of the wear sleeve 36. Additional annular sealing elements 72 and 74, which are also preferably hydrodynamic seals of the character described above, are located within spaced seal grooves of the housing 12 and are in sealing engagement with the outer cylindrical polished surface 60 of the wear sleeve 36. The seals 62 and 72 cooperate with the housing 12 and the wear sleeve to define an annular lubricant chamber 66 and seals 72 and 74 cooperate with the housing 12 and the wear sleeve and with an annular lubricant supply groove 76 to define another annular lubricant chamber.

Within the spirit and scope of the present invention it is desirable to pressurize the lubricant within the lubricant chambers in response to contaminant pressure. It is also desirable to achieve pressurization of the lubricant within the lubricant chambers in absence of contaminant pressure to ensure lubrication of the sealing interfaces of the various seals with the relatively rotatable surface of the wear sleeve or other rotary member, and to hold the seals in position to prevent skew-related wear and that would otherwise occur if the seals were not held in position by lubricant pressure. The housing structure defines a contaminant pressure passage 320 which is in communication with an annular piston chamber 322 having a bottom wall 324 and a pair of spaced facing cylindrical wall surfaces 326 and 328. A pair of annular piston members 330 and 332 are moveable within the annular piston chamber and are urged in one axial direction by respective compression springs 108 and 156. The compression springs act on the pistons to apply mechanical spring force which develops lubricant pressure within the respective lubricant chambers which feeds lubricant to the annular hydrodynamic seals 62,72 and 74 and thus provides for efficient abrasive exclusion of the respective sealing interfaces in absence of contaminant pressure. Thus, as operation of the rotary pumping system of a well is initiated and before pumped fluid reaches the wellhead for application of significant contaminant pressure to the pistons, spring force enhanced lubricant pressurization continuously occurs and holds the seals in unskewed orientation, and thus prevents excessive wear of the seals.

The annular piston 330 has an annular seal 334 which is disposed in sealing engagement with the cylindrical internal surface 326 of the side wall 306 of the housing structure. The annular piston 330 is shown at its maximum upward position, with an annular shoulder 336 being in stopped engagement with a piston seal retainer element 338 having an annular seal 340 thereof being in sealing engagement with a cylindrical extension 342 of the annular piston 330. The retainer element 338 is secured to the side wall 306 of the housing 302 by a threaded connection 331 and is sealed with respect to the side wall by an annular sealing element 339.

Annular piston member 332 carries an external seal 350 which is in sealing engagement with a cylindrical sealing surface 352 of the piston 330, thus providing for a sealed relationship between the pistons 330 and 332 regardless of the positions thereof within the annular piston chamber 322. The piston 332 is also provided with an annular seal 354 which is in sealing engagement with the outer cylindrical surface 328 of the housing 12. The annular piston 332 is also shown in its maximum upward position, with its annular shoulder 358 in stopped engagement with the bearing and seal retainer element 48. A cylindrical extension 360 of the annular piston 332 is in sealing engagement with a circular seal 362 of the bearing and seal retainer 48.

For pressurization of lubricant within the lubricant chamber 66 within which the bearings are located, a lubricant supply passage 364 is drilled or otherwise formed in the wall structure of the housing element 12 and is in communication with the lubricant supply chamber 366 which is defined between the piston 332 and the bearing and seal retainer 48. A lubricant supply port 368 in the depending annular bearing retainer 46 communicates the lubricant supply passage with the lubricant chamber 66. Thus, as the piston 332 is acted upon by contaminant pressure, the piston applies pressure developing force to the lubricant within the lubricant chamber 66 to provide for lubrication and pressurized positioning of the seals. In absence of contaminant pressure, the compression spring 108 acting on the piston 332 develops sufficient force on the piston to ensure the feed of pressurized lubricant within the lubricant chamber to ensure lubrication and pressurized positioning of the seals.

Seals that are used in applications with little or no differential pressure can become locally skewed due to the combined effects of compression and thermal expansion. If seal skew is present, rotation can cause environmental abrasives to impinge upon and abrade the sealing lip, and consequently abrade the shaft or other rotary element. The compression springs of the various embodiments set forth herein achieve mechanically induced hydraulic pressurization of the lubricant medium. This hydraulic pressure acts on the various seals and forces the seals against their gland walls even when contaminant pressure is absent and thus eliminates any skew of the seals. This feature ensures minimal wear and extended service life of the seals.

For pressurization of lubricant within the annular lubricant chamber defined between the seals 72 and 74, the wall structure of the housing 12, the bottom wall 304 and the side wall 306 is drilled to form a lubricant supply passage 370 which is in communication with the annular lubricant groove 76 and with the lubricant supply chamber 372 between the piston 330 and the piston seal retainer element 338. Thus, as the piston 330 is subjected to upwardly directed force imparted to the piston by contaminant pressure or spring force or both, pressurized lubricant is supplied to the annular lubricant chamber between the seals 72 and 74, thus providing the seals with efficient lubrication at all times.

In view of the foregoing it is evident that the present invention is one well adapted to attain all of the objects and features hereinabove set forth, together with other objects and features which are inherent in the apparatus disclosed herein.

As will be readily apparent to those skilled in the art, the present invention may easily be produced in other specific forms without departing from its spirit or essential characteristics. The present embodiment is, therefore, to be considered as merely illustrative and not restrictive, the scope of the invention being indicated by the claims rather than the foregoing description, and all changes which come within the meaning and range of equivalence of the claims are therefore intended to be embraced therein. contains abrasives which accelerate packing wear, and cause corresponding wear of the mating rod surface. By contrast, in the sealing arrangement of FIG. 10, (as described previously in conjunction with the preferred embodiment), any leakage that occurs past the rotary seals will be lubricant leakage rather than abrasive laden contaminant leakage, due to the lubricant pressure being higher than the contaminant pressure. This lubricant leakage provides for effective seal lubrication and functions also to flush away any contaminant matter that might be present in the scaling interface of the seal with the rotary shaft.

At page 34, line 15, after “piston” insert —140—:

In the Drawings:

Applicants have filed herewith a substitute set of all drawings, with FIGS. 1, 2, 3, 5 and 9 having been amended for addition and correction of reference numerals. Prints of the original drawings have been attached, showing the reference numeral changes of the original drawings.

1. (Amended) A contaminant pressure responsive [lubricant pressure amplified] rotary seal [cartridge] assembly, comprising:
a housing having a rotary shaft passage therethrough and having at least a portion of said rotary shaft passage being subject to contaminant pressure;
a rotary member being disposed for rotation within said rotar shaft passage;
a plurality of spaced seals establishing sealing between said housing and said rotary member and defining at least one lubricant chamber between said housing and said rotary member;
at least one cylinder having a lubricant supply chamber containing a quantity of lubricant and being in fluid communication with said at least one lubricant chamber;
[a] at least one piston being moveable within said at least one cylinder and having a first surface area exposed to lubricant within said lubricant supply chamber and a second surface area being different from said first surface area and being exposed to said contaminant pressure, said contaminant pressure acting on said second surface area developing a lubricant pressure within said at least one lubricant chamber being different from said contaminant pressure.

2. (Amended) The [lubricant pressure amplified] contaminant pressure responsive rotary seal [cartridge] assembly of claim 1, comprising:
said at least one lubricant chamber being first and second lubricant chambers [chamber] between said housing and said rotary member; and
[said at least one lubricant chamber being first and second lubricant chambers being isolated from one another; and]
said at least one cylinder being first and second cylinders each having a piston moveable therein and defining a lubricant supply chamber, said first lubricant chamber being in fluid communication with said lubricant supply chamber of said first cylinder, said second lubricant chamber being in fluid communication with said lubricant supply chamber of said second cylinder.

3. [14.] (Amended) The [lubricant pressure amplified] contaminant pressure responsive rotary seal [cartridge] assembly of claim [12] 2, comprising:
said pistons [having differing pressure transmitting areas in contact with lubricant within said first and second pylinders and] developing differing ratios of lubricant pressure to contaminant pressure.

4. [3.] (Amended) The [lubricant pressure amplified] contaminant pressure responsive rotary seal [cartridge] assembly of claim 1, comprising:
said at least one cylinder being releasably secured to said housing [member]; and
[structure on said housing [member] and said at least one cylinder defining a [fluid] lubricant communication passage between said lubricant supply chamber and said at least one lubricant chamber and a contaminant pressure communication passage communicating [the cylinder with] said contaminant pressure to said second surface area.

5. [4.] (Amended) The [lubricant pressure amplified] contaminant pressure responsive rotary seal [cartridge] assembly of claim [3] 1, comprising:
[said housing and said at least one cylinder establishing a housing/cylinder interface; and
seals establishing sealing between said housing and said cylinders at said housing/cylinder interface and preventing leakage of lubricant and pressurized contaminant fluid from said communication passages.]
said at least one piston having a piston stem defining a pressure relief recess preventing overfilling of said lubricant supply chamber.

6. [5.] (Amended) The [lubricant pressure amplified] contaminant pressure responsive rotary seal [cartridge] assembly of claim 1, comprising:
said at least one cylinder being separate from said housing and having a [lubricant supply chamber and a] contaminant pressure chamber; and
a lubricant pressure communication passage interconnecting said lubricant supply chamber and said at least one lubricant chamber; and
a contaminant pressure communication passage communicating said contaminant pressure chamber with said contaminant pressure.

7. [6.] (Amended) The [lubricant pressure amplified] contaminant pressure responsive rotary seal [cartridge] assembly of claim 1, comprising:
said at least one cylinder having a wall defining an opening therein;
a piston stem extending from said piston and extending through said opening; and
a spring member applying spring force to said piston stem and causing said piston to apply said spring force to said lubricant within said lubricant supply chamber, thus [ensuring] causing mechanically induced [hydraulic] pressurization of said lubricant [in absence of contaminant pressure].

8. [7.] (Amended) The [lubricant pressure amplified] contaminant pressure responsive rotary seal [cartridge] assembly of claim 1, comprising:
said rotary member being a rotary wear sleeve,
[a] said rotary wear sleeve being located at least partially within said drive shaft passage of said housing and defining a [central] sleeve passage[, said plurality of seals having sealing engagement with said rotary wear sleeve];
[at least one bearing being located within said housing and supporting said rotary wear sleeve for rotation relative to said housing;]
[said rotary member being] a rotary shaft extending through said [central] sleeve passage and being sealed to said rotary wear sleeve; and
a sleeve drive system imparting rotation of said rotary shaft to said rotary wear sleeve.

9. [8.] (Amended) The [lubricant pressure amplified] contaminant pressure responsive rotary seal [cartridge] assembly of claim [7] 8, wherein said sleeve drive system comprises:
a first drive member being located on said wear sleeve; and
a second drive member being rotatably driven by said rotary shaft and having driving engagement with said first drive member for rotation of said rotary wear sleeve by said rotary shaft.

10. [9.] (Amended) The [lubricant pressure amplified] contaminant pressure responsive rotary seal [cartridge] assembly of claim [7] 8, wherein said sleeve drive system comprises:
said rotary wear sleeve defining a first collet actuation surface; and
a collet member being located about said rotary shaft and having a second collet actuation surface in contact with said first collet actuation surface; and
a retainer member being adjustably received by said rotary wear sleeve and having positioning engagement with said collet member and being adjusted relative to said rotary wear sleeve to cause interaction of said first and second collet actuation surfaces for establishing collet clamping of said rotary wear sleeve to said rotary shaft and for centering said rotary wear sleeve with said rotary shaft.

11. [10.] (Amended) The [lubricant pressure amplified] contaminant pressure responsive rotary seal [cartridge] assembly of claim [7] 8, wherein said sleeve drive system comprises:
a collet member being located about said rotary shaft and having a first collet actuation surface [in contact with said first collet actuation surface];
a retainer member being adjustably received by said rotary wear sleeve and defining a second collet actuation surface in contact with said first collet actuation surface; and
[a] said retainer member having adjustable connection with said rotary wear sleeve and having positioning engagement with said collet member and being adjusted relative to said wear sleeve to cause interaction of said first and second collet actuation surfaces for establishing collet clamping of said rotary wear sleeve to said rotary shaft.

12. [11.] (Amended) The [lubricant pressure amplified] contaminant pressure responsive rotary seal [cartridge] assembly of claim 1, comprising:
said at least one cylinder being mounted to said housing and located externally of said housing;
said lubricant chamber being of annular configuration and encompassing said rotary member;
a lubricant passage defined by said housing and said at least one cylinder and communicating between said annular lubricant chamber [with] and said lubricant supply chamber.

13. [12.] (Amended) The [lubricant pressure amplified] contaminant pressure responsive rotary seal [cartridge] assembly of claim 1, comprising:
said at least one cylinder being a first and second cylinders each being mounted to said housing and located externally of said housing;
said at least one lubricant chamber being axially spaced first and second lubricant chambers of annular configuration encompassing said rotary member and;
lubricant passages being defined by said housing and said first and second cylinders and communicating said annular lubricant chambers [of said first and second cylinders] respectively with said first and second lubricant supply chambers.

14. [13.] (Amended) The [lubricant pressure amplified] contaminant pressure responsive rotary seal [cartridge] assembly of claim [12] 13, comprising:
contaminant passages [being defined by said housing and said first and second cylinders and] communicating said contaminant pressure [of said passage] to said first and second cylinders for imparting contaminant pressure induced force to said pistons for piston induced pressurization of said lubricant within said lubricant supply chambers of said cylinders.

15. (Amended) The [lubricant pressure amplified] contaminant pressure responsive rotary seal [cartridge] assembly of claim 1, comprising:
said at least one cylinder being [a] first and second cylinders each being separate from said housing;
said at least one lubricant chamber being axially spaced first and second lubricant chambers of annular configuration within said housing and encompassing said rotary member; and
lubricant passages [interconnecting said first and second cylinders and] communicating said [annular] first and second lubricant chambers [of said first and second cylinders respectively] with said first and second lubricant supply chambers.

16. (Amended) The [lubricant pressure amplified] contaminant pressure responsive rotary seal [cartridge] assembly of claim [15] 1, comprising:
at least one bearing [being supported by said housing and being located within said first lubricant chamber and] establishing rotary support for said rotary [wear sleeve] member.

17. (Amended) The [lubricant pressure amplified] contaminant pressure responsive rotary seal [cartridge] assembly of claim 1, comprising:
at least one of said plurality of spaced seals being a hydrodynamic seal[s] and reacting with relative motion of lubricant responsive to rotation of said rotary member for establishing hydrodynamic lubrication of [sealing interfaces thereof with] said hydrodynamic seal and said rotary member.

18. (Amended) The [lubricant pressure amplified] contaminant pressure responsive rotary seal [cartridge] assembly of claim 1, comprising:
a bushing being located [within] by said housing [and having bearing engagement with said rotary member, said bushing providing bearing support for said rotary member and defining a minimal clearance with said rotary member] for minimizing particulate intrusion [from said passage of said housing] into said at least one cylinder.

19. (Amended) The [lubricant pressure amplified] contaminant pressure responsive rotary seal [cartridge] assembly of claim 1, comprising:
a threaded mounting adapter being defined by the lower end of said housing; and
a mounting flange having threaded connection with said threaded mounting adapter and adapting said housing for mounting to a flanged fluid flow element.

20. (Amended) The [lubricant pressure amplified] contaminant pressure responsive rotary seal [cartridge] assembly of claim 1, comprising:
a mounting flange member being defined by said housing and adapting said housing for mounting to a flanged fluid flow element.

21. (Amended) The [lubricant pressure amplified] contaminant pressure responsive rotary seal [cartridge] assembly of claim 1, comprising:
a mounting base member;
said housing defining a lower mounting end being disposed in sealed relation with said [housing) mounting base member;
at least one retainer member securing said housing in fixed relation with said mounting base member; and
said at least one cylinder being a pair of cylinders each being supported by said mounting base member [and being disposed in spaced relation with said housing].

22. (Amended) The [lubricant pressure amplified] contaminant pressure responsive rotary seal [cartridge] assembly of claim 1, comprising:
said housing defining at least one internal bearing surface;
said housing and said plurality of spaced seals defining said at least one lubricant chamber; and
said rotary member being a rotatable shaft having bearing engagement with said at least one internal bearing surface [and having] a portion of said rotatable shaft being in contact with lubricant within said at least one lubricant chamber[;].

23. (Amended) The [lubricant pressure amplified] contaminant pressure responsive rotary seal [cartridge] assembly of claim 22, comprising:
said at least one lubricant chamber being a pair of axially spaced annular lubricant chambers separated by said plurality of spaced seals.

24. (Amended) The [lubricant pressure amplified] contaminant pressure responsive rotary seal [cartridge] assembly of claim 1, comprising:
said housing defining a seal gland about said rotary member;
said plurality of spaced seals defining a seal stack within said seal gland; and
a lubricant supply passage communicating from said lubricant supply chamber to [with] said seal gland and providing said plurality of seals with contaminant pressure responsive lubrication.

25. (Amended) The [lubricant pressure amplified] contaminant pressure responsive rotary seal [cartridge] assembly of claim 24, comprising
a lantern ring being located intermediate said seal gland and providing at least a portion of said lubricant chamber;
said plurality of spaced seals being located on both axial sides of said lantern ring; and
said lubricant supply passage intersecting said seal gland at said lantern ring.

26. (Amended) The [lubricant pressure amplified] contaminant pressure responsive rotary seal [cartridge] assembly of claim [24]1, comprising:
[said plurality of spaced seals being alternating annual cup seals and 0-ring seals arranged in alternating stacked relation within said seal gland.] said at least one lubricant chamber being first and second lubricant chambers between said housing and said rotary member:
said at least one cylinder being first and second cylinders each having a piston moveable therein and defining a lubricant supply chamber said first lubricant chamber being in fluid communication with said lubricant supply chamber of said first cylinder, said second lubricant chamber being in fluid communication with said lubricant supply chamber of said second cylinder: and
at least one of said pistons developing lubricant pressure in at least one of said first and second lubricant chambers that is less than contaminant fluid pressure.

27. (Amended) The [lubricant pressure amplified] contaminant pressure responsive rotary seal [cartridge] assembly of claim 1, [being provided for a motorized shaft rotating mechanism and] comprising:
a mounting flange extending from said housing; and
[the] a motorized shaft rotating mechanism being mounted to and supported by said mounting flange.

28. (Amended) The [lubricant pressure amplified] contaminant pressure responsive rotary seal [cartridge] assembly of claim [25] 27, comprising
said at least one cylinder being located below said mounting flange, permitting servicing [thereof] of said at least one cylinder while said motorized shaft rotating mechanism is in operation without risk of [contract] contact by servicing personnel with said rotary member.

29. (Amended) The [lubricant pressure amplified] contaminant pressure responsive rotary seal [cartridge] assembly of claim 1, comprising
said at least one cylinder being a pair of cylinders each being integral with and projecting from said housing.

30. (Amended) The [lubricant pressure amplified] contaminant pressure responsive rotary seal [cartridge] assembly of claim [24] 1, comprising
said housing defining said at least one cylinder said at least one cylinder and said housing defining an [annual] annular piston chamber;
said at least one lubricant supply chamber being a pair of lubricant supply chambers,
said at least one lubricant chamber being a pair of spaced lubricant chambers[:], and
said at least one piston being a pair of annular pistons located within said annular piston chamber and defining [a] said pair of lubricant supply chambers each being in lubricant supplying communication with respective spaced lubricant chambers.
Add the following new claims:

31. (NEW) A rotary seal assembly for a top drive apparatus of a submersed rotary artificial lift pump for an oil well and having a rotary pump drive string connected in driving relation with the submersed rotary artificial lift pump, comprising:
a seal housing having a rotary shaft passage being exposed to pressurized contaminant fluid of the well and defining an annular seal gland and a lubricant supply passage in communication with said annular seal gland;
a rotary shaft of the rotary pump drive string being rotatable within said rotary shaft passage;
a plurality of annular seals being located within said annular seal gland and defining a seal stack having sealing engagement with said annular seal gland and with said rotary shaft and having first and second seal stack sections, said lubricant supply passage communicating with said annular seal gland intermediate said first and second stack sections;
a lubricant pressurization chamber having a lubricant therein and being in lubricant supplying communication with said lubricant supply passage and being exposed to pressurized contaminant fluid of the oil well;
a moveable partition within said lubricant pressurization chamber being in pressure transmitting contact with said lubricant of said lubricant pressurization chamber and separating said lubricant from said pressurized contaminant fluid; and
at least one spring applying spring force to said moveable partition in a direction developing lubricant pressure within said lubricant pressurization chamber and said lubricant supply passage and between said first and second seal stack sections for urging said first and second seal stack sections in opposite directions within said annular seal gland and preventing pressurized contaminant fluid intrusion into said annular seal gland.

32. (NEW) The rotary seal assembly of claim 31, comprising:
a packing retainer being supported by said seal housing and securing said seal stack within said annular seal gland, said packing retainer being adjustable for mechanical pressure adjustment of said seal stack to permit leakage of said lubricant from the lubricant chamber into the contaminant fluid for lubrication of said plurality of annular seals of said seal stack.

33. The rotary seal assembly of claim 31, comprising:
said moveable partition being a piston member having a first portion thereof in contact with said lubricant and~a second portion thereof in contact with said pressurized contaminant fluid of the well, said piston member being responsive to spring force and contaminant pressure for imparting fluid pressure to said lubricant which exceeds contaminant fluid pressure.
Remarks
The present amendment is filed for the purpose of more clearly establishing patentable distinction of the various claims of the present application over the teachings of the documents that are identified in the International Search Report and for pointing out distinguishing features of the present invention that are claimed herein and are not present in the references of record. The present
